(19) United States
(12) Patent Application Publication
(10) Pub. No.: US 2007/0204181 A1
(43) Pub. Date: Aug. 30, 2007

(54) Information processing apparatus and power consumption method

(76) Inventor: Kazuhiko Tsuji, Hamura-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/710,814

(22) Filed: Feb. 26, 2007

(30) Foreign Application Priority Data
Feb. 28, 2006 (JP) 2006-051524

(51) Int. Cl. G06F 1/32

(52) U.S. Cl. 713/320

(57) ABSTRACT

According to one embodiment, there is provided an information processing apparatus including a control portion to change the operation mode to the first power consumption mode when a remaining capacity of the battery is reduced to a first capacity if the action of changing the operation mode to the first power consumption mode is set, and change the operation mode to the second power consumption mode when the remaining capacity of the battery is reduced to a second capacity lower than the first capacity if the action of changing the operation mode to the second power consumption mode is set.

### CROSS-REFERENCE TO RELATED APPLICATIONS

This application is based upon and claims the benefit of priority from Japanese Patent Application No. 2006-051524, filed Feb. 28, 2006, the entire contents of which are incorporated herein by reference.

### BACKGROUND

1. Field

One embodiment of the invention relates to an information processing apparatus equipped with a battery and a power consumption control method thereof.

2. Description of the Related Art

Generally, in a battery-driven information processing apparatus, such as a personal computer, when the charge remaining in the battery is reduced below the predetermined level, the apparatus issues an alarm indicating battery exhaustion and changes into a preset low-power consumption operation mode.

There is a known technique, in which an event desired by the user is generated when the charge remaining in the battery reduces to the level designated by the user. For example, Jpn. Pat. Appln. KOKAI Publication No. 2000-214965 discloses a technique of generating an event desired by the user, such as an event of playing back sound data stored in a designated sound file, an event of outputting a message stored in a designated text file or an event of activating an application program stored in a designated program file.

Besides, a standby mode and a hibernation mode are known as operation modes, into which the apparatus changes when the charge remaining in the battery is reduced below the predetermined amount.

If the apparatus changes into the standby mode, since power is continuously supplied to the main memory or the like, the battery will become immediately exhausted. On the other hand, if the apparatus changes into the hibernation mode, since power is not supplied to the main memory or the like, the battery will not become immediately exhausted.

Thus, once the apparatus changes into the hibernation mode, the user cannot continue operating the apparatus any longer, although a certain amount of the charge is left in the battery.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary front view showing a state in which a display unit of a computer according to an embodiment of the invention is opened;

FIG. 2 is an exemplary block diagram showing a system configuration of the computer;

FIG. 3 is an exemplary diagram showing part of information stored in an EEPROM in the battery;

FIG. 4 is an exemplary diagram showing the relationship between a battery voltage and a discharge ratio;

FIG. 5 is an exemplary block diagram showing an example of the configuration of elements concerned with a process of detecting a low battery level;

FIG. 6 is an exemplary diagram for explaining a register in an embedded controller (EC);

FIG. 7 is an exemplary diagram showing an example of the functional configuration of a utility controlled by an operating system (OS);

FIG. 8 is an exemplary diagram showing an example of the functional configuration of a BIOS;

FIG. 9 is an exemplary diagram showing an example of the setting screen implemented by the utility;

FIG. 10 is an exemplary flowchart showing an operation of a power supply controller (PSC) and the EC; and

FIG. 11 is an exemplary flowchart showing an operation of a basic input/output system (BIOS) and the OS.

### DETAILED DESCRIPTION

Various embodiments according to the invention will be described hereinafter with reference to the accompanying drawings. In general, according to one embodiment of the invention, there is provided an information processing apparatus including a control portion to change the operation mode to the first power consumption mode when a remaining capacity of the battery is reduced to a first capacity if the action of changing the operation mode to the first power consumption mode is set, and change the operation mode to the second power consumption mode when the remaining capacity of the battery is reduced to a second capacity lower than the first capacity if the action of changing the operation mode to the second power consumption mode is set.

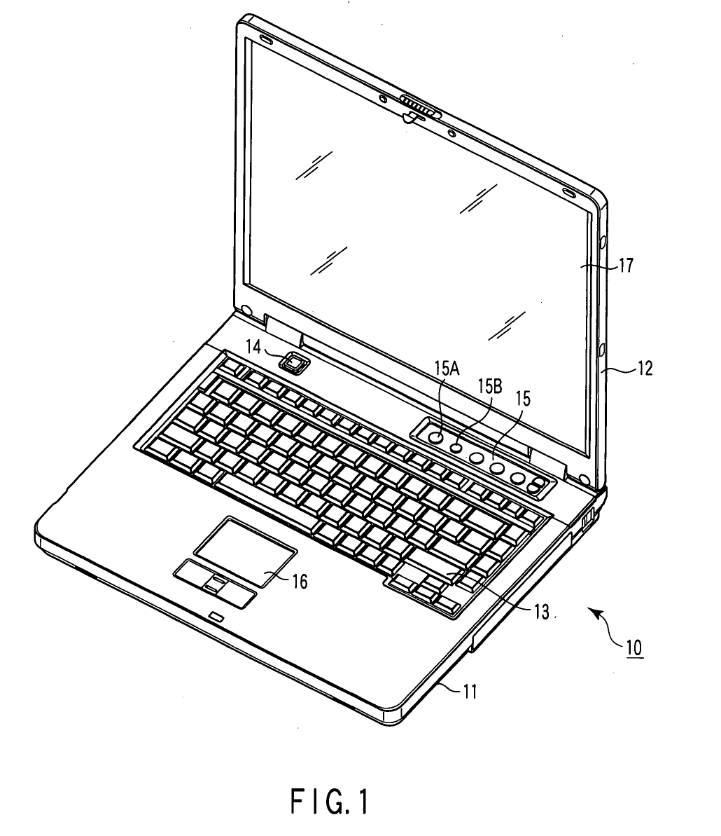

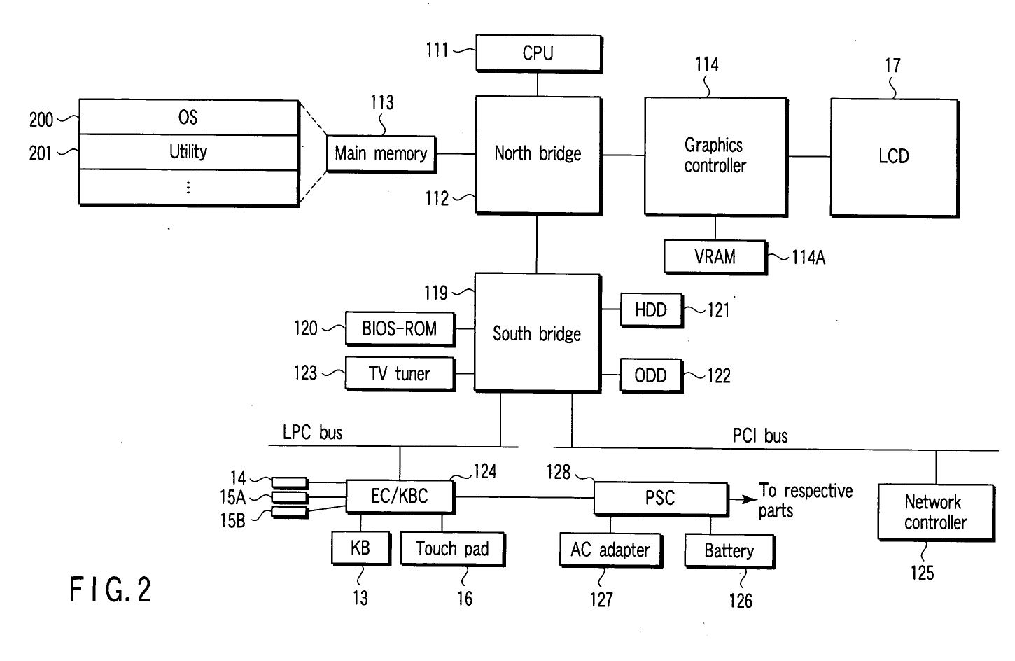

First, a configuration of an information processing apparatus according to an embodiment of the invention will be described with reference to FIGS. 1 and 2. The information processing apparatus is implemented as, for example, a notebook computer 10.

FIG. 1 is a front view showing a state in which a display unit of the notebook computer 10 is opened. The computer 10 includes a computer main body 11 and a display unit 12. The display unit 12 incorporates a display device including a thin film transistor liquid crystal display (TFT-LCD) 17. The display screen of the LCD 17 is located substantially at the center of the display unit 12.

The display unit 12 is attached to the main body 11 so as to be rotatable relative to the main body 11 between an open position and a closed position. The main body 11 has a thin box-shaped casing. A keyboard 13, a power button 14 to power on and off the computer 10, an input operation panel 15, a touch pad 16, etc.

The input operation panel 15 is an input device, including a plurality of buttons to activate the corresponding functions. The user pushes one of the buttons to input the corresponding event. The buttons include a TV activation button 15A and a DVD/CD activation button 15B. The TV activation button 15A is a button to activate the TV function to play back, view, listen to and record TV broadcast program data. The DVD/CD activation button 15B is a button to play back video content recorded in DVDs or CDs.

The system configuration of the computer 10 will now be described with reference to FIG. 2.

As shown in FIG. 2, the computer 10 includes a CPU 111, a north bridge 112, a main memory 113, a graphics controller 114, a south bridge 119, a BIOS-ROM 120, a hard disk drive (HDD) 121, an optical disk drive (ODD) 122, a TV tuner 123, an embedded controller/keyboard controller IC (EC/KBC) 124, a network controller 125, a battery 126, an AC adapter 127, a power supply controller (PSC) 128, etc.

The CPU 111 is a processor to control operations of the computer 10. It executes software, such as an OS (Operating System) 200 loaded from the hard disk drive (HDD) 121 into the main memory 113 and utilities (or applications) 201 controlled by the OS.

The CPU 111 also executes a system basic input/output system (BIOS) stored in the BIOS-ROM 120. The system BIOS is a program to control hardware.

The north bridge 112 is a bridge device which connects a local bus of the CPU 111 and the south bridge 119. The north bridge 112 incorporates a memory controller which controls access to the main memory 113. The north bridge 112 also has a function of performing communication with the graphics controller 114 via an accelerated graphics port (AGP) bus or the like.

The graphics controller 114 is a display controller, which controls the LCD 17 used as a display monitor of the computer 10. The graphics controller 114 reads image data stored in a video memory (VRAM) 114A and display the data on the LCD 17.

The south bridge 119 controls devices on a low pin count (LPC) bus and devices on a peripheral component interconnect (PCI) bus. The south bridge 119 incorporates an integrated drive electronics (IDE) controller to control the HDD 121 and the ODD 122. The south bridge 119 also has a function of controlling the TV tuner 123 and controlling access to the BIOS-ROM 120.

The HDD 121 is a storage device, which stores various software and data. The optical disc drive (ODD) 122 is a drive unit to drive recording media, such as DVDs and CDs storing video content. The TV tuner 123 is a receiving device, which receives broadcast program data, for example, TV programs, from outside.

The network controller 125 is a communication device, which executes communication with an external network, for example, the Internet.

The embedded controller/keyboard controller IC (EC/KBC) 124 is a 1-chip microcomputer, in which an embedded controller to control electric power and a keyboard controller, to control a keyboard (KB) 13 and a touch pad 16, are integrated.

The power supply controller (PSC) 128 generates necessary power and supply it to the components of the computer 10 based on the power from the battery 126 or external power supplied through the AC adapter 127, in accordance with instructions from the embedded controller (EC).

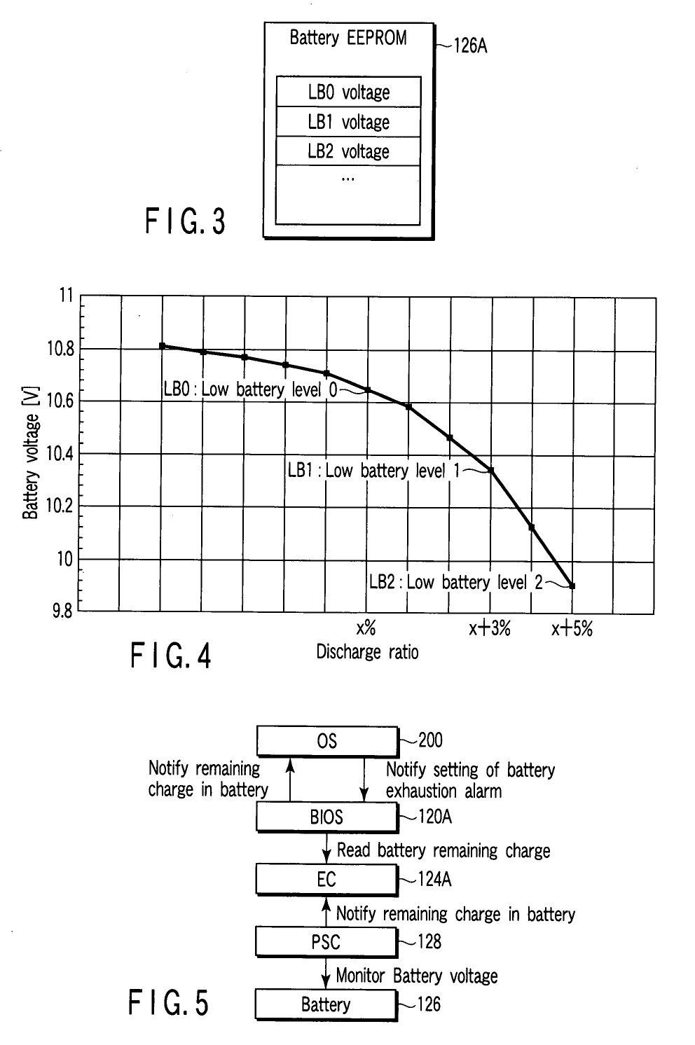

FIG. 3 is a diagram showing part of information stored in an EEPROM in the battery 126.

The battery 126 includes an EEPROM 126A storing various information relating to the battery. The EEPROM 126A stores parameters (numerical values) indicative of three low battery levels LB0, LB1 and LB2 as reference values to determine whether the battery 126 is in a low battery status. These values are used in the PSC 128 etc.

The level LB0 is used as a trigger when the operation mode of the computer 10 is changed into the standby mode. For example, if an action, of changing the computer 10 to the standby mode when the battery 126 is brought into the low battery status, is preset, the change to the standby mode is executed when the electronic voltage is reduced below the level LB0.

The level LB1, which is lower than the level LB0, is used as a trigger when the operation mode of the computer 10 is changed into the hibernation mode. For example, if an action, of changing the computer 10 to the hibernation mode when the battery 126 is brought into the low battery status, is preset, the change to the hibernation mode is executed when the electronic voltage is reduced below the level LB1.

The level LB2, which is lower than the level LB1, is used as a trigger when the operation mode of the computer 10 is changed into the stop mode. For example, if an action, of changing the computer 10 to the stop mode when the battery 126 is brought into the low battery status, is preset, the change to the stop mode is executed when the electronic voltage is reduced below the level LB2.

FIG. 4 is a diagram showing the relationship between a battery voltage and a discharge ratio.

As shown in FIG. 4, as the discharge ratio (%) of the battery 126 increases, the charge remaining in the battery decreases and accordingly the voltage (V) of the battery 126 lowers. The low battery levels LB0, LB1 and LB2 respectively correspond to the battery voltages at the discharge ratios x (%), x+3 (%) and x+5 (%). As the voltage (V) of the battery 126 lowers, the low battery levels LB0, LB1 and LB2 are detected in this order by the PSC 128.

FIG. 5 is a block diagram showing an example of the configuration of elements concerned with a process of detecting a low battery level.

The battery 126, the PSC 128, the EC 124A, the BIOS 120A and the OS 200 are concerned with the process of detecting a low battery level.

The OS 200 notifies the BIOS 120A of settings of a battery exhaustion alarm action (for example, setting of “changing the operation mode to the hibernation mode when the battery is brought into a low battery status”), which is preset in the utility (or application) 201. The OS 200 also checks whether the battery has been exhausted or not based on the remaining capacity (mAh) of the battery 126 notified from the BIOS 120A, and determines whether to execute the battery exhaustion alarm action. When the OS 200 executes the alarm action, it instructs the EC 124A to change the computer 10 to the set operation mode (for example, the hibernation mode). Further, the OS 200 can display the remaining capacity (mAh) of the battery 126 notified from the BIOS 120A on a screen of the LCD 17 in terms of percentage.

The battery 126 includes the EEPROM 126A storing parameters indicative of the low battery levels LB0, LB2 and LB2, as described above.

The PSC 128 can monitor the voltage of the battery 126 via the terminals of the battery 126. The PSC 128 can detect the low battery levels LB0, LB1 and LB2 based on the parameters stored in the EEPROM 126A of the battery 126. Each time the PSC 128 detects that the voltage of the battery 126 reaches the level LB0, LB1 or LB2, it can transmit the value indicative of the corresponding remaining capacity (mAh) to the EC 124A. This transmission is not limited to the case of a low battery level. The PSC 128 can transmit the value of the remaining charge corresponding to the detected battery voltage to the EC 124A every moment. Besides, the PSC 128 can also transmit a value indicative of the full capacity of the battery 126 to the EC 124A.

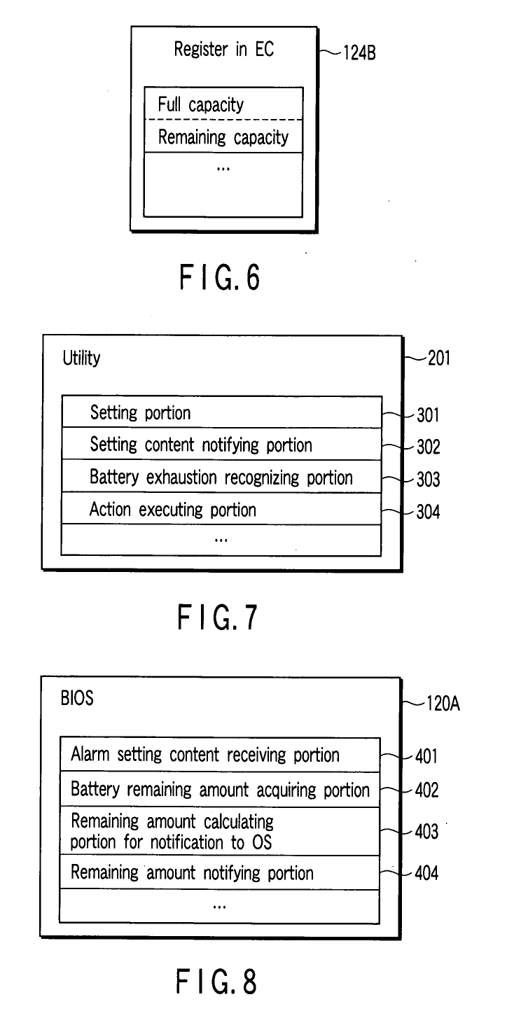

The EC 124A includes a register 124B as shown in FIG. 6. The register 124B can store a value indicative of the full capacity of the battery 126 and a value indicative of the remaining charge in the battery 126. When the EC 124A receives a new value indicative of the remaining capacity in the battery 126, it writes the value in a predetermined area in the register 124B and notifies the BIOS 120A that the remaining capacity has been updated.

The BIOS 120A reads information from the register 124B inside the EC 124A upon receipt of the notification of the update from the EC 124A. If the action of changing the computer 10 to the standby mode is preset, the BIOS 120A notifies the OS 200 of a value, as a remaining capacity, obtained by subtracting a predetermined value as a margin (in this embodiment, a capacity C₂% corresponding to 2% of the full capacity) from the remaining capacity represented by the information read from the register 124B. For example, if the remaining capacity represented by the information read from the register 124B is the remaining capacity C0 corresponding to the level LB0, the BIOS 120A notifies the OS 200 of the value, as the remaining capacity, obtained by subtracting the capacity C₂% from the remaining capacity C0. In this case, the OS 200 recognizes battery exhaustion, and executes the action of changing the computer 10 to the standby mode.

If the action of changing the computer 10 to the hibernation mode is preset, the BIOS 120A does not perform the above subtraction, and notifies the OS 200 of a value, as a remaining capacity, obtained by adding a predetermined value (in this embodiment, a capacity C₁% corresponding to 1% of the full capacity) to the remaining capacity represented by the information read from the register 124B. For example, if the remaining capacity represented by the information read from the register 124B is the remaining capacity C1 corresponding to the level LB1, the BIOS 120A notifies the OS 200 of the value, as the remaining capacity, obtained by adding the capacity C₁% to the remaining capacity C1. It is assumed that the value obtained by adding the capacity C₁%, which corresponds to 1% of the full capacity, to the remaining capacity C1 is equal to the value obtained by subtracting the capacity C₂%, which corresponds to 2% of the full capacity, from the remaining capacity C0. In this case, the OS 200 recognizes battery exhaustion, and executes the action of changing the computer 10 to the hibernation mode.

The above arithmetic operation may not necessarily be executed by the BIOOS 120A, but may be executed by other software or hardware instead.

FIG. 7 is a diagram showing an example of the functional configuration of the utility 201 controlled by the OS 200.

The utility 201 has various functional portions, such as a setting portion 301, a setting content notifying portion 302, a battery exhaustion recognizing portion 303 and an action executing portion 304.

The setting portion 301 sets information designated by the user through a setting screen relating to a battery exhaustion alarm action.

The setting content notifying portion 302 notifies the BIOS 120A of content set by the setting portion 301 (for example, setting of “changing the operation mode to the hibernation mode when the battery is brought into a low battery status”).

The battery exhaustion recognizing portion 303 recognizes battery exhaustion when the remaining capacity of the battery 126 notified from the BIOS 120A is equal to or lower than the reference value.

The action executing portion 304 instructs the EC 124A to change the computer 10 to the operation mode indicated in the setting content (for example, the hibernation mode), when the battery exhaustion recognizing portion 303 recognizes battery exhaustion.

FIG. 8 is a diagram showing an example of the functional configuration of the BIOS 120A.

The BIOS 120A has various functional portions, such as an alarm setting content receiving portion 401, a battery remaining amount acquiring portion 402, a remaining amount calculating portion 403 for notification to the OS, and a remaining amount notifying portion 404.

The alarm setting content receiving portion 401 receives and retains setting content relating to the battery exhaustion alarm action notified from the OS 200.

The battery remaining amount acquiring portion 402 reads information including the remaining capacity from the register 124B in the EC 124A upon receipt of the notification of the update from the EC 124A.

The remaining amount calculating portion 403 for notification to the OS calculates the remaining capacity to be notified to the OS by subtracting a predetermined value from the remaining capacity represented by the information read by the battery remaining amount acquiring portion 402, if the action of changing the computer 10 to the standby mode is preset. On the other hand, if the action of changing the computer 10 to the hibernation mode is preset, the remaining amount calculating portion 403 for notification to the OS calculates the remaining capacity to be notified to the OS by adding another predetermined value to the remaining capacity represented by the information read by the battery remaining amount acquiring portion 402.

The remaining amount notifying portion 404 notifies the OS 200 of the remaining capacity calculated by the remaining amount calculating portion 403 for notification to the OS.

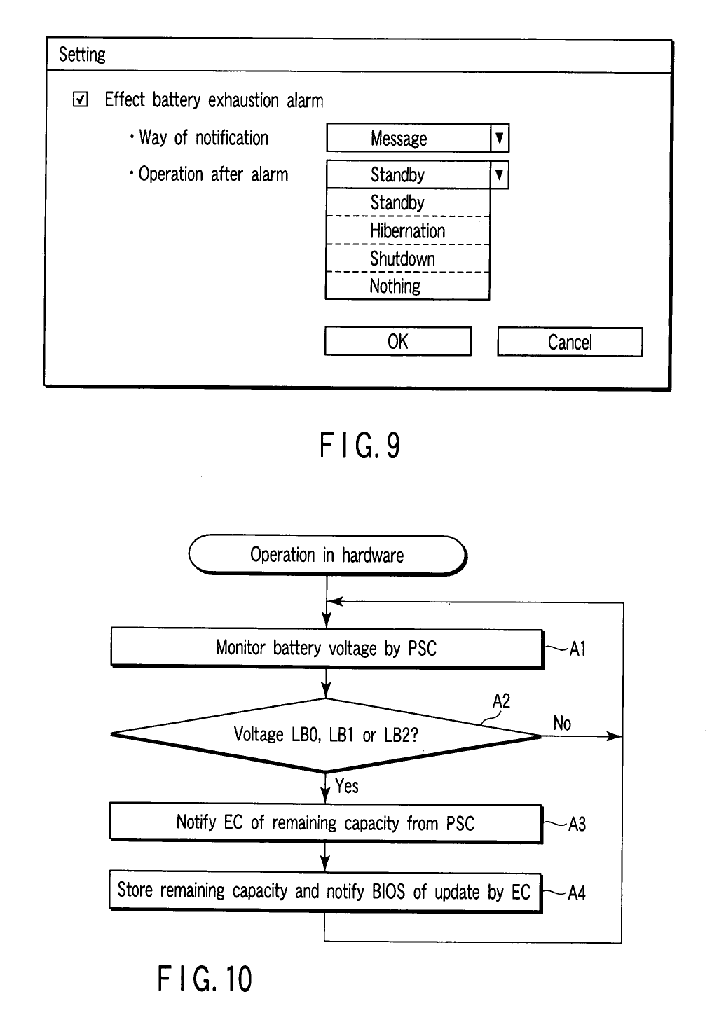

FIG. 9 is a diagram showing an example of the setting screen implemented by the utility 201.

FIG. 9 shows a setting screen relating to the battery exhaustion alarm action, which is implemented by the setting portion 301 in the utility 201. The battery exhaustion alarm action can be effected, for example, by checking the check box in the setting screen as shown in FIG. 9. In this case, the user can designate a way of notification of the alarm and an operation after the alarm as desired.

Items “Message”, “Sound”, etc. are available as the way of notification of the alarm. The power saving modes of “Standby”, “Hibernation”, etc. are available as the operation after the alarm. Items “Shutdown” and “Nothing” are also available as the operation after the alarm. When the user designates a way of notification and a mode as desired and then pushes the OK button, the setting is completed.

Operations of the PSC 128 and the EC 124A will now be described with reference to the flowchart shown in FIG. 10.

The PSC 128 detects a voltage of the battery 126 through the terminals of the battery 126, and monitors whether the voltage has been reduced to LB0, LB1 or LB2 (block A1). If the voltage of the battery 126 has been reduced to LB0, LB1 or LB2 (YES in block A2), the PSC 128 transmits the value of the corresponding remaining capacity to the EC 124A (block A3). Then, the EC 124A writes the value of the remaining capacity sent from the PSC 128 in the predetermined area in the register 124B, and notifies the BIOS 120A of the occurrence of the update of the remaining capacity (block A4). Thereafter, the process from block A1 to A4 is repeated.

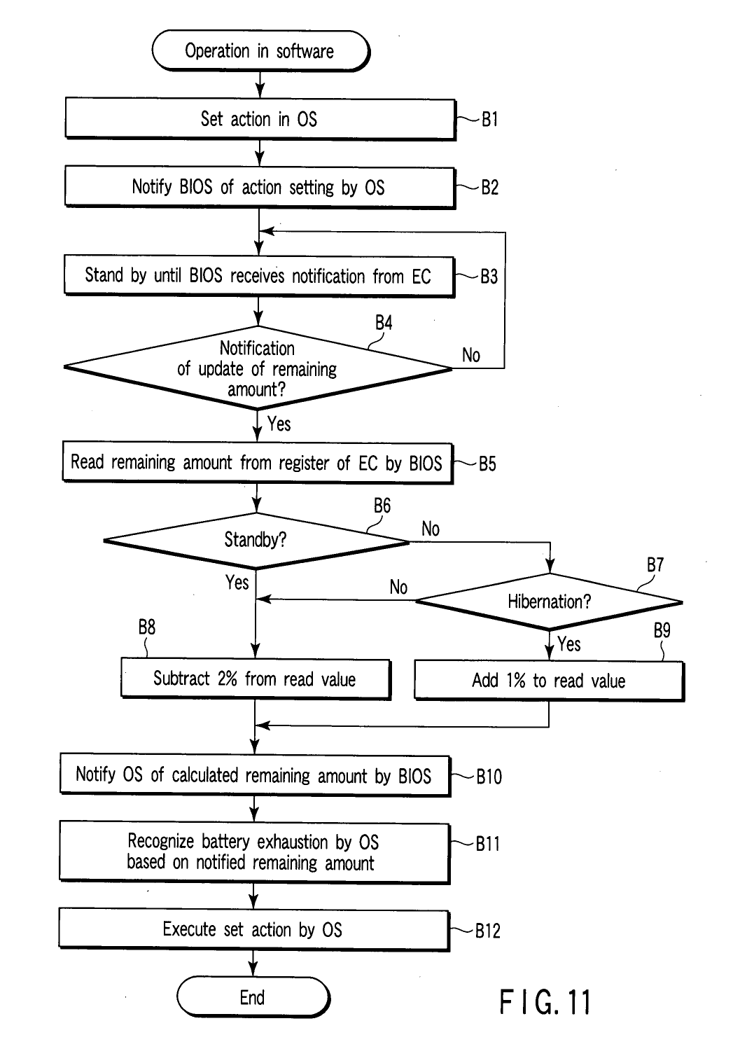

Next, operations of the BIOS 120A and the OS 200 will be described with reference to the flowchart shown in FIG. 11.

When the utility 201 controlled by the OS 200 performs settings designated by the user through the setting screen of the battery exhaustion alarm action (block B1), it notifies the BIOS 120A of the setting content (block B2).

After the BIOS 120A receives the notification, it stands by until it receives a notification of update from the EC 124A (block B3).

Upon receipt of the notification of update from the EC 124A (YES in block B4), the BIOS 120A reads the remaining capacity of the battery 126 from the register 124B in the EC 124A (block B5). Then, the BIOS 120A checks what is set as the operation after the alarm represented by the setting content notified from the OS 200 (blocks B6 and B7).

If “Standby” is set as the operation after the alarm (YES in block B6), the BIOS 120A subtracts 2% of the full capacity from the remaining capacity read from the register 124B (block B8).

If “Hibernation” is set as the operation after the alarm (NO in block B6 and YES in block B7), the BIOS 120A adds 1% of the full capacity to the remaining capacity read from the register 124B (block B9).

If “Shutdown” is set as the operation after the alarm (NO in block B7), the BIOS 120A subtracts 2% of the full capacity from the remaining capacity read from the register 124B (block B8).

Then, the BIOS 120A notifies the OS 200 of the remaining capacity after the arithmetic operation (block B10).

Upon receipt of the remaining capacity, if the OS 200 detects that the remaining capacity is equal to or lower than the reference value, it recognizes battery exhaustion (block B11) and executes the set battery exhaustion alarm action (block B12).

As described above, according to the embodiment of the invention, if the action of changing the computer to the hibernation mode is set in the battery exhaustion alarm action, the BIOS 120A notifies the OS 200 of the value obtained by adding the predetermined value to the remaining capacity acquired from the EC 124A. Therefore, the computer can be changed to the hibernation mode at a level lower than that in the conventional art. Consequently, the user can continue working with the computer for a longer period of time.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a battery;
a setting portion to set an action of changing an operation mode of the information processing apparatus to a first power consumption mode in which the information processing apparatus is operated at a first power consumption or to a second power consumption mode in which the information processing apparatus is operated at a second power consumption lower than the first power consumption; and
a control portion to change the operation mode to the first power consumption mode when a remaining capacity of the battery is reduced to a first capacity if the action of changing the operation mode to the first power consumption mode is set, and change the operation mode to the second power consumption mode when the remaining capacity of the battery is reduced to a second capacity lower than the first capacity if the action of changing the operation mode to the second power consumption mode is set.

2. The information processing apparatus according to claim 1, wherein the control portion changes the operation mode to the first power consumption mode based on a value obtained by subtracting a first predetermined value from the first capacity if the action of changing the operation mode to the first power consumption mode is set, and changes the operation mode to the second power consumption mode based on a value obtained by adding a second predetermined value to the second capacity if the action of changing the operation mode to the second power consumption mode is set.

3. The information processing apparatus according to claim 2, wherein the value obtained by subtracting the first predetermined value from the first capacity is equal to the value obtained by adding the second predetermined value to the second capacity.

4. The information processing apparatus according to claim 1, wherein the first power consumption mode is a standby mode and the second power consumption mode is a hibernation mode.

5. An information processing apparatus, comprising:
a battery;
a setting portion to set an action of changing an operation mode of the information processing apparatus to a first power consumption mode in which the information processing apparatus is operated at a first power consumption or to a second power consumption mode in which the information processing apparatus is operated at a second power consumption lower than the first power consumption;
a mode changing portion to change the operation mode to the first power consumption mode or the second power consumption mode; and
a notifying portion to notify the mode changing portion of a value obtained by subtracting a first predetermined value from a first capacity when a remaining capacity of the battery is reduced to the first capacity if the action of changing the operation mode to the first power consumption mode is set, and notify the mode changing portion of a value obtained by adding a second predetermined value to a second capacity lower than the first capacity when the remaining capacity of the battery is reduced to the second capacity if the action of changing the operation mode to the second power consumption mode is set,
the mode changing portion being configured to change the power consumption mode based on the value notified from the notifying portion.

6. The information processing apparatus according to claim 5, wherein the value obtained by subtracting the first predetermined value from the first capacity is equal to the value obtained by adding the second predetermined value to the second capacity.

7. The information processing apparatus according to claim 5, wherein the first power consumption mode is a standby mode and the second power consumption mode is a hibernation mode.

8. A power consumption control method applied to an information processing apparatus having a battery, the method comprising:
setting an action of changing an operation mode of the information processing apparatus to a first power consumption mode in which the information processing apparatus is operated at a first power consumption or to a second power consumption mode in which the information processing apparatus is operated at a second power consumption lower than the first power consumption; and
changing the operation mode to the first power consumption mode when a remaining capacity of the battery is reduced to a first capacity if the action of changing the operation mode to the first power consumption mode is set, and changing the operation mode to the second power consumption mode when the remaining capacity of the battery is reduced to a second capacity lower than the first capacity if the action of changing the operation mode to the second power consumption mode is set.

9. The power consumption control method according to claim 8, wherein the changing the operation mode includes changing the operation mode to the first power consumption mode based on a value obtained by subtracting a first predetermined value from the first capacity if the action of changing the operation mode to the first power consumption mode is set, and changing the operation mode to the second power consumption mode based on a value obtained by adding a second predetermined value to the second capacity if the action of changing the operation mode to the second power consumption mode is set.

10. The power consumption control method according to claim 9, wherein the value obtained by subtracting the first predetermined value from the first capacity is equal to the value obtained by adding the second predetermined value to the second capacity.

11. The power consumption control method according to claim 8, wherein the first power consumption mode is a standby mode and the second power consumption mode is a hibernation mode.
